(19) United States
(12) Patent Application Publication
(10) Pub. No.: US 2007/0265419 A1
(43) Pub. Date: Nov. 15, 2007

(54) Process for driving gas blowers or fans in a solid-state polymerization process using steam from a terephthalic acid plant

(76) Inventors: Richard Gill Bonner, Lexington, SC (US); Albert Bob Debenport, Columbia, SC (US)

Correspondence Address: Dennis V. Carmen;Eastman Chemical Company, P.O. Box 511, Kingsport, TN, 37662-5075, US

(21) Appl. No.: 11/431,237

(22) Filed: May 10, 2006

(51) Int. Cl. C08G 63/02

(52) U.S. Cl. 528/272

(57) ABSTRACT

A method for integrating energy resources between a process for synthesizing terephthalic acid and a process for the solid-state polymerization of a polyester, which comprises generating steam from the synthesis of terephthalic acid, providing the steam to a condensing turbine to generate power, applying the power to a gas blower or fan to create a stream of gas and applying the stream of gas to fluidize polyester pellets in a crystallization and/or solid-state polymerization process.

### FIELD OF THE INVENTION

The present invention is directed to a method for integrating energy resources between a process for synthesizing terephthalic acid and a process for the solid state polymerization of a polyester.

### BACKGROUND

Processes for producing crude and purified terephthalic acid are well-known. For example, U.S. Pat. No. 4,605,763, which is incorporated by reference herein, discloses a method of producing crude terephthalic acid by oxidizing para-xylene in acetic acid solvent with molecular oxygen in the presence of a catalyst. It further discloses a method of purifying crude terephthalic acid by contacting the crude terephthalic acid with oxygen-containing gas at elevated temperature and pressure. These processes for producing crude and purified terephthalic acid release carbon dioxide and steam as byproducts.

The solid state polymerization process is also well-known. For example, U.S. Pat. No. 6,740,377, which is incorporated herein by reference, describes crystallization process and a solid state polymerization phase. In the crystallization process, amorphous polyester pellets are maintained at a temperature below their melting point for a time sufficient for the amorphous polyester pellets to form crystallized polyester pellets that have a higher melting point than the amorphous polyester pellets. In the solid stating phase, crystallized polyester pellets are maintained at a temperature that is usually higher than the temperature of the crystallization process, but still below the melting point of the crystallized polyester pellets, for a time sufficient to advance the molecular weight of the polymer in the solid phase (as indicated by an increase in their lt.V.) to obtain a product having the desired characteristics, such as intrinsic viscosity or degree of polymerization. In some instances, the crystallization process alone can be completed with no need for a separate solid stating phase.

U.S. Pat. No. 4,064,112, which is incorporated herein by reference, describes the advantages of employing a crystallization process before the solid stating phase. For example, crystallizing the amorphous polyester pellets in the crystallization process increases the temperature at which the solid stating phase can occur, thereby increasing the efficiency of the reaction and reducing the time required for the solid stating phase. High temperatures in the solid stating phase are preferred to allow for the reaction to occur at an economical rate. Accordingly, amorphous pellets can preferably be crystallized in the crystallizing process before the solid stating phase begins.

It is well-known to circulate gas, which may comprise air, inert gas, or any other suitable gas, in order to control the temperature of the reaction and carry away reaction gases such as ethylene glycol and acetaldehyde. For example, U.S. Pat. No. 3,117,950, which is incorporated herein by reference, discloses circulating inert gas to control the temperature of the reaction and carry away reaction gases. Circulating gas can also serve to fluidize the polyester pellets in both the crystallization and solid stating phases, which can improve the efficiency of the reaction by preventing the pellets from sticking together. Circulating gas in the crystallization or solid stating phases, however, requires the use of gas blowers or fans. These gas blowers or fans require power, which adds a significant cost to crystallization process and/or the solid stating phase.

### SUMMARY OF THE INVENTION

We have discovered a method for using the steam generated during the synthesis of terephthalic acid in a process for the crystallization and/or solid state polymerization of a polyester. The methods of the present invention can provide significant energy cost savings in a process for the solid state polymerization of a polyester.

One embodiment of the invention is a method for integrating energy resources between a process for synthesizing terephthalic acid and a process for the crystallization and/or solid-state polymerization of a polyester, which comprises:

a) generating steam from the synthesis of terephthalic acid,

b) providing the steam to a condensing turbine to generate electric power,

c) converting the electric power to mechanical energy to generate a stream of gas, and

d) applying the stream of gas to polyester pellets in a crystallization process and/or a solid-state polymerization process.

Another embodiment of the invention is a method for integrating energy resources between a process for synthesizing terephthalic acid and a process for the solid-state polymerization of a polyester, which comprises:

a) generating heat from the synthesis of terephthalic acid,

b) transferring the generated heat to water to produce steam,

c) providing the steam to a turbine to generate electric power,

d) converting the electric power to mechanical power which creates a stream of gas, and

e) applying the stream of gas to polyester pellets in a crystallization process or a solid-state polymerization process.

### BRIEF DESCRIPTION OF THE DRAWINGS

The accompanying drawings illustrate embodiments of the invention and, together with the description, serve to explain certain principles of the invention.

FIG. 1 illustrates one embodiment of the claimed invention, wherein off gas from a water column is expanded in a turbine to power a gas blower or fan.

FIG. 2 illustrates another embodiment of the claimed invention, wherein steam provided by a steam generator is expanded in a turbine to power a gas blower or fan.

### DETAILED DESCRIPTION OF THE INVENTION

As used in the specification and the appended claims, the singular forms “a,” “an,” and “the” include plural referents unless the context clearly dictates otherwise. For example, reference to making or using a polyester, using a condensing turbine, or using a gas blower is intended to include the making or using of singular and a plurality of polyesters, condensing turbines, or gas blowers. It should also be noted that the term “or” is generally employed in its sense including “and/or” unless the context clearly dictates otherwise.

It is also to be understood that the mention of one or more method steps does not preclude the presence of additional method steps before or after the combined recited steps or intervening method steps between those steps expressly identified. Moreover, the lettering of process steps is a convenient means for identifying discrete activities or steps, and unless otherwise specified, recited process steps can be arranged in any sequence.

The term polyester as use herein includes polyester homopolymers and copolyesters. Polyesters include, for example polyethylene terephthalate (“PET”) and copolyesters of PET. Suitable polyesters are generally known in the art and may be formed from, for example, dicarboxylic acid components and glycol components such as aromatic dicarboxylic acids, esters of dicarboxylic acids, anhydrides of dicarboxylic esters, glycols and mixtures thereof. For instance, polyesters can be formed from repeat units comprising terephthalic acid, dimethyl terephthalate, isophthalic acid, d methyl isophthalate, dimethyl 2,6-napthalenedicarboxylate, 2,6-naphthalenedicarboxylic acid, ethylene glycol, 1,4-cyclohexane-dimethanol, and 1,4-butanediol.

All numbers expressing quantities used in the specification and claims are to be understood as being modified in all instances by the term “about.” Accordingly, unless indicated to the contrary, the numerical parameters set forth in the present specification and attached claims are approximations that may vary depending upon the desired properties sought to be obtained by the present invention. It should be understood that the exact numerical values disclosed also form embodiments of the invention. At the very least, and not as an attempt to limit the application of the doctrine of equivalents to the scope of the claims, each numerical parameter should be construed in light of the number of reported significant digits and by applying ordinary rounding techniques.

The present invention is directed to a method for integrating energy resources between a process for synthesizing terephthalic acid in a terephthalic acid plant and a process for the solid-state polymerization of a polyester. The invention can reduce the energy cost required for the solid-state polymerization of a polyester, while simultaneously using waste steam generated during the synthesis of terephthalic acid.

In one embodiment, the present invention provides a method for integrating energy resources between a process for synthesizing terephthalic acid and a process for the solid-state polymerization of a polyester, which comprises:

a) generating steam from the synthesis of terephthalic acid,

b) providing the steam to a condensing turbine to generate electric power,

c) converting the electric power to mechanical energy to generate a stream of gas, and

d) applying the stream of gas to polyester pellets in a crystallization process and/or a solid-state polymerization process.

This embodiment may comprise in d) applying the stream of gas to fluidize the polyester pellets in a crystallization process, or alternatively or in addition, applying the stream of gas to fluidize the polyester pellets in a solid stating phase of the solid-state polymerization process. Whether during a crystallization process or during the solid stating phase, the invention includes, for instance, fluidizing the polyester pellets at a temperature of at least about 2° C. below the melt temperature of the pellets being fluidized, or at a temperature of at least about 10° C. below the melt temperature of the pellets being fluidized.

This embodiment of the invention may also comprise generating the steam at a pressure of, for example, from 5 to 100 psi, from 45 to 85 psi, or from 60 to 70 psi. The condensing turbine in this embodiment can provide, for instance, at least 10%, at least 50%, or all of the power for the gas blower or fan. This embodiment may also include a step of removing impurities from the steam before providing the steam to the condensing turbine.

In another embodiment, the present invention provides a method for integrating energy resources between a process for synthesizing terephthalic acid and a process for the solid-state polymerization of a polyester, which comprises:

a) generating heat from the synthesis of terephthalic acid,

b) transferring the generated heat to water to produce steam,

c) providing the steam to a turbine to generate electric power,

d) converting the electric power to mechanical power which creates a stream of gas, and

e) applying the stream of gas to polyester pellets in a crystallization process or a solid-state polymerization process.

This embodiment may comprise in e) applying the stream of gas to fluidize the polyester pellets in a crystallization process, or alternatively or in addition, applying the stream of gas to fluidize the polyester pellets in a solid stating phase of the solid-state polymerization process. Whether during the crystallization process or during the solid stating phase, the invention includes, for instance, fluidizing the polyester pellets at a temperature of at least about 2° C. below the melt temperature of the pellets being fluidized, or at a temperature of at least about 10° C. below the melt temperature of the pellets being fluidized.

This embodiment of the invention may also comprise generating the steam at a pressure of, for example, from 5 to 100 psi, 45 to 85 psi, or from 60 to. 70 psi. The condensing turbine in this embodiment can provide, for instance, at least 10%, at least 50%, or all of the power for the gas blower or fan.

In any embodiments of the invention, the generated power may be in the form of mechanical or electrical energy. In one embodiment, mechanical energy generated by the condensing turbine may be used, either alone or in combination with a set of gears and/or belts, to power a gas blower or fan. In another embodiment, the condensing turbine generates electrical energy to power a gas blower or fan.

In any embodiments of the invention, the plant for synthesizing terephthalic acid can be situated conveniently in the vicinity of or adjacent to the solid stating facility so that the steam is readily available in the solid stating process.

One embodiment of the invention comprises applying a stream of gas to fluidize polyester pellets in a crystallization process, which may optionally be housed within the same vessel as used to solid state polymerize the pellets, another embodiment of the invention comprises applying a stream of gas to fluidize polyester pellets in a solid stating phase of the solid-state polymerization process, and another embodiment of the invention comprises applying a stream of gas to fluidize polyester pellets in a crystallization process, followed by applying a stream of gas to fluidize polyester pellets in a solid stating phase, within the same vessel or each process within separate vessels.

In any embodiments, the condensing turbine may provide some or all power needed for the blowers or fans. Other sources of power may therefore be used to supplement power provided to the gas blowers or fans. In some embodiments, the gas blower or fan powered according to the invention is the only gas blower or fan used to fluidize polyester pellets. In other embodiments, the gas blowers or fans powered according to the invention are only one or a subset of a plurality of gas blowers or fans used to fluidize the polyester pellets.

As discussed earlier, solid-state polymerization is a process well known in the art. For example, U.S. Pat. No. 4,064,112, which is incorporated herein by reference, describes a typical solid-state polymerization process where amorphous polyester pellets that have been prepared by melt phase polymerization are first crystallized at a temperature from 10° C. to 100° C. below their melt temperature during the crystallization phase and then further held at a temperature of at least 10° C. below their melt temperature for a sufficiently long time, e.g., 2-40 hours, in the presence of either vacuum or dry nitrogen to increase their intrinsic viscosity during the solid stating phase. U.S. Pat. No. 6,740,377, which is incorporated herein by reference, describes another typical solid state polymerization process where the crystallization phase is conducted under an inert gas atmosphere at a temperature of 150° C. to 250° C. for 0.5 to 8 hours, and the solid stating phase is conducted under reduced pressure at a temperature of 230° C. to 350° C. for 0.1 to 6 hours. U.S. Pat. Nos. 4,256,861, 4,539,390, and 2,901,466, the entire disclosures of which are incorporated herein by reference, also disclose solid state polymerization processes. The solid state polymerization of the present invention may be performed by any of the methods described herein.

During the crystallization phase, which occurs before the solid stating phase, amorphous polyester pellets are crystallized in a fluidized bed at a temperature below their melt temperature, usually at a temperature of at least about 2° C. below. their melt temperature. For example, U.S. Pat. No. 6,740,377 discloses subjecting the polyester particles to a temperature of about 140° C. to about 2° C. below their melt temperature.

Amorphous polyester pellets typically have melting points greater than 100° C. Accordingly, the crystallization phase is typically carried out at a temperature range from 100° C. to 300° C. For example, U.S. Pat. No. 3,117,950 discloses a crystallization temperature of from 170° C. to 300° C., U.S. Pat. No. 6,74,377 discloses a crystallization temperature of 100° C. to 260° C., while U.S. Pat. No. 4,161,578, discloses a crystallization temperature range from 180° C. to 220° C. For purposes of this invention, any suitable amorphous polyester pellets may be used in the crystallization phase and amorphous polyester pellets should be maintained at a temperature below their melting point for a length of time sufficient to create a crystallized polyester pellet. Typically, the amorphous polyester pellets are crystallized to at least a 15% degree of crystallization. Higher crystallization degrees can also be used, for example at least 25%, or at least 30%, or at least 35%, or at least 40%.

After the amorphous polyester pellets have been crystallized, the solid stating phase begins in which the crystallized polyester pellets are heated at a temperature below their melting point for anywhere from 1 minute up to 100 hours. In one embodiment the solid stating phase takes place at a temperature of at least about 2° C. below the melting point of the crystallized polyester pellets.

The crystallized polyester pellets generally have a higher melting point than the amorphous polyester pellets. This characteristic allows the solid stating phase to occur at a higher temperature without the disadvantages, such as sticking and melting, that could occur absent the crystallization phase.

During both the crystallization phase and the solid stating phase, a stream of gas can be circulated to fluidize the polyester pellets, regulate the temperature of the polyester pellets, and carry away reaction gases such as ethylene glycol and acetaldehyde. Suitable gases include, for example, inert gases and air. Inert gases include helium, argon, hydrogen, nitrogen and mixtures thereof. It should be understood that the inert gas may contain some air. At high temperatures that are often encountered in the solid-stating phase, inert gas is preferred because it minimizes any discoloration that may be caused by non-inert gases such as air. At lower temperatures that are often encountered in the crystallization phase, either inert or non-inert gases may be used without discoloring the pellets. The amount of gas flow can be adjusted anywhere from 1 to 1,000 milliliters of inert gas per minute per gram of polyester pellets in order to fluidize the polyester pellets, regulate the temperature, and/or carry away reaction gases. The stream of gas may thereafter be recycled for use again in fluidizing the polyester pellets.

The amorphous polyester pellets of the invention can be made by a number of processes well-known in the art. For example, the polyesters can be produced by melt phase polymerization. If the polymers are to be used to make plastic containers, polymerization is carried our to a molecular weight suitable for said container applications, for example by producing polymers having an intrinsic viscosity of at least 0.30 dL/g, or at least 0.50 dL/g, or at least 0.65 dL/g, or at least 0.70 dL/g, or at least 0.72 dL/g, or at least 0.74 dL/g, or at least 0.76 dL/g. In one embodiment, the process of the invention is applied to a crystallization process, and the lt.V. of the polyester polymer is at least 0.72 dL/g.

The lt.V. values described throughout this description are set forth in dL/g units as calculated from the inherent viscosity measured at 25° C. in 60/40 wt/wt phenol/tetrachloroethane. The inherent viscosity is calculated from the measured solution viscosity. The following equations describe such solution viscosity measurements and subsequent calculations to lh.V. and from lh.V. to lt.V:
ηᵢₙₕ=[lntₛ/tₒ)]/C

where ηᵢₙₕ=Inherent viscosity at 25° C. at a polymer concentration of 0.50 g/100 mL of 60% phenol and 40% 1,1,2,2-tetrachloroethane
ln=Natural logarithm
tₛ=Sample flow time through a capillary tube

tₒ=Solvent-blank flow time through a capillary tube
C=Concentration of polymer in grams per 100 mL of solvent (0.50%)

The intrinsic viscosity is the limiting value at infinite dilution of the specific viscosity of a polymer. It is defined by the following equation:

$${η}_{int} = {lim}_{C -> 0} ( {η}_{sp} / C ) = {lim}_{C -> 0} ln ( {η}_{r} / C )$$

where ηᵢₙₜ=Intrinsic viscosity
ηᵣ=Relative viscosity=tₛ/tₒ
ηₛₚ=Specific viscosity=ηᵣ−1

Instrument calibration involves replicate testing of a standard reference material and then applying appropriate mathematical equations to produce the “accepted” I.V. values.
Calibration Factor=Accepted IV of Reference Material/Average of Replicate Determinations
Corrected lhV=Calculated lhV×Calibration Factor

The intrinsic viscosity (ltV or ηᵢₙₜ) may also be calculated using the Billmeyer equation as follows:
ηᵢₙₜ=0.5[e^{0.5×Corrected lhV}−1]+(0.75×Corrected lhV)

Melt phase polymerization can be followed by the formation of particles, such as pellets, for use in the solid state polymerization process.

As also discussed earlier, the synthesis of terephthalic acid is a process well-known in the art that involves the oxidation of para-xylene. U.S. Pat. No. 4,605,763, which is incorporated herein by reference, discloses a method of producing crude terephthalic acid by oxidizing para-xylene in acetic acid solvent with molecular oxygen in the presence of a catalyst. It further discloses a method of purifying crude terephthalic acid by contacting the crude terephthalic acid with oxygen-containing gas at elevated temperature and pressure. These processes for producing crude and purified terephthalic acid release carbon dioxide and steam as byproducts.

### DETAILED EMBODIMENTS OF THE INVENTION

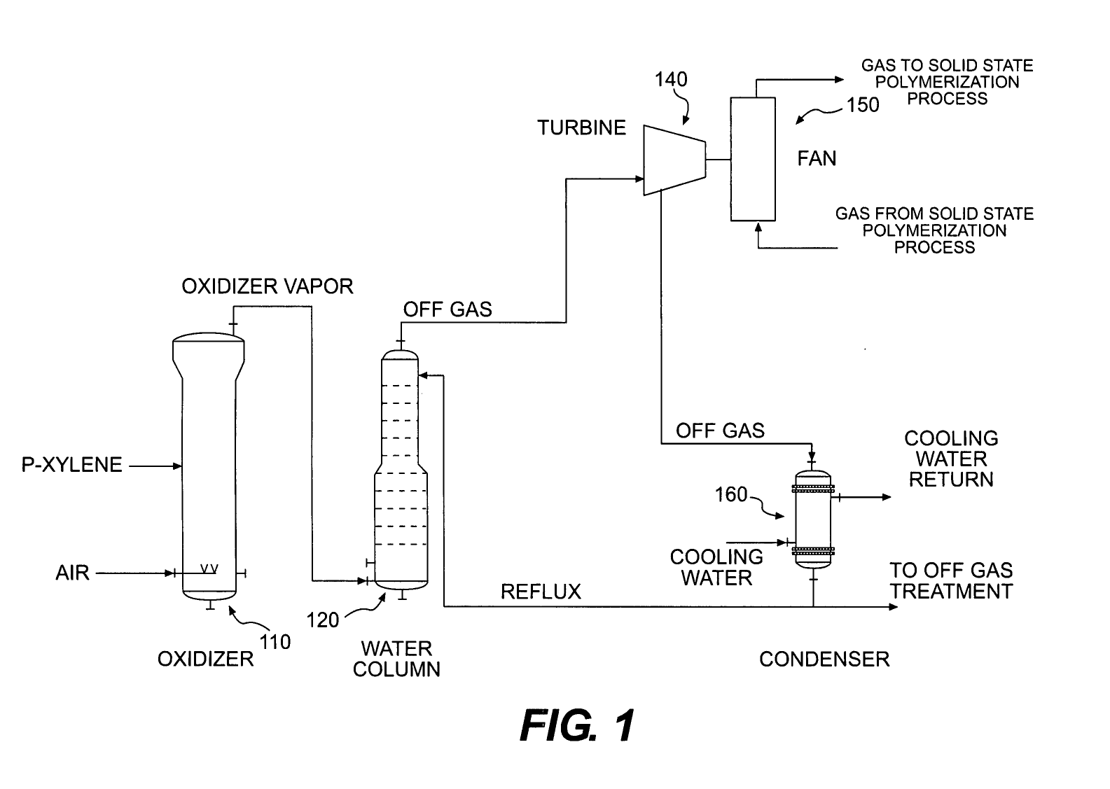

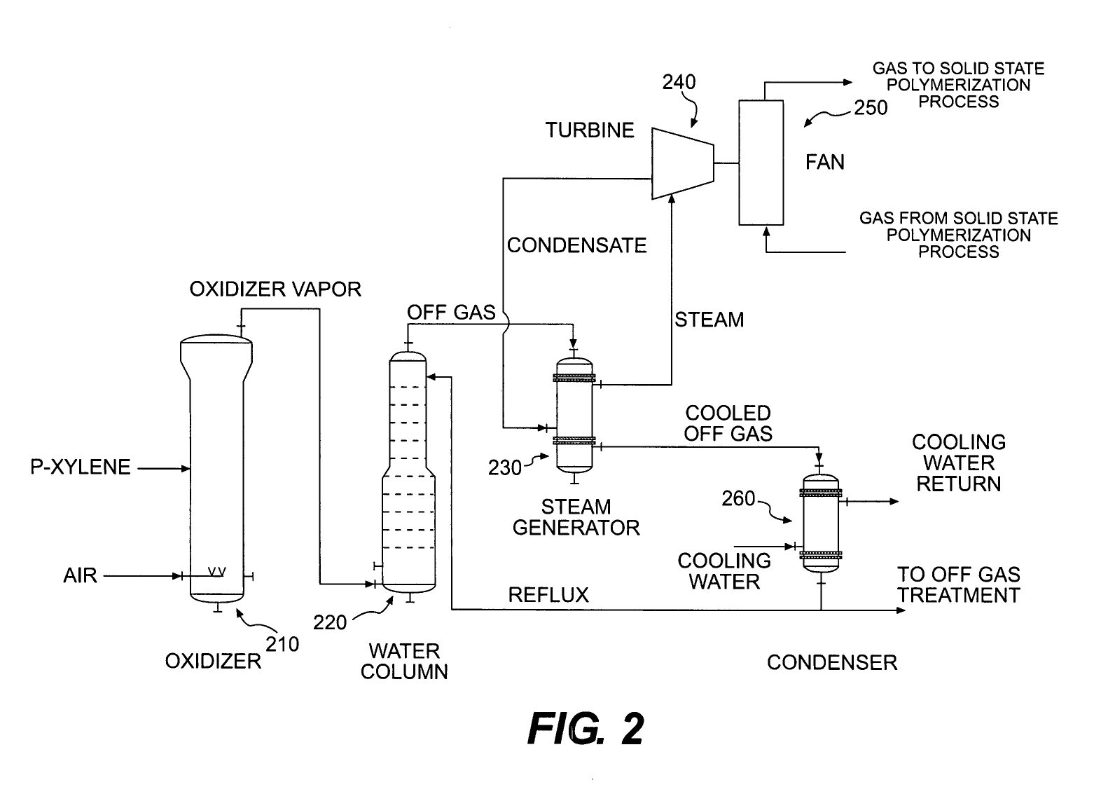

As illustrated in FIGS. 1 and 2, para-xylene and compressed air are fed to an oxidizer (110; 210) where the partial oxidation of para-xylene is carried out in an acetic acid solvent. One product of the oxidation is water, which is a vapor at the temperature and pressure in the oxidizer (110; 210). Water vapor is taken overhead from the oxidizer (110; 210) with the unused portion of the air and a certain amount of acetic acid vapor.

This material, which is labeled oxidizer vapor in FIGS. 1 and 2, is fed to a water column (120; 220). The water column (120; 220) is a distillation column designed to separate acetic acid and water. Water leaves the column as vapor along with non-condensables from the air. This stream is labeled as “Off Gas” in FIGS. 1 and 2.

The off gas is under pressure and hot. In one embodiment depicted by FIG. 1, the off gas can be expanded in a turbine (140) to power a gas blower or fan (150) that can circulate gas to a solid state polymerization process. In another embodiment depicted by FIG. 2, the off gas can be cooled in a steam generator (230) where the steam generator applies heat from the off gas to a condensate stream, or any other suitable water or water vapor stream, to generate steam that can be expanded in a turbine (240) to power a gas blower or fan (250) that can circulate gas to a solid state polymerization process.

In any of the embodiments described above, the cooled off gas can be sent through a condenser (160; 260) where water vapor can be condensed and used as a reflux stream for the water column (120; 220) or sent to off gas treatment. Moreover, in any of the embodiments described above, the gas circulated by the gas blower or fan (150; 250) may comprise air.

In other embodiments, steam may be sent to one or more additional condensing turbines, power may be provided to one or more additional gas fans or blowers, and gas may be circulated to either the crystallizing phase or the solid stating phase, or both.

We claim:

1. A method for integrating energy resources between a process for synthesizing terephthalic acid and a process for the solid-state polymerization of a polyester, which comprises:
a) generating steam from the synthesis of terephthalic acid,
b) providing the steam to a turbine to generate electric power,
c) converting the electric power to mechanical energy to generate a a stream of gas, and
d) applying the stream of gas to polyester pellets in a crystallization process and/or solid-state polymerization process.

2. The method according to claim 1, which comprises in d) applying the stream of gas to fluidize the polyester pellets in a crystallization process.

3. The method according to claim 1, which comprises in d) applying the stream of gas to fluidize the polyester pellets in a solid state polymerization process.

4. The method according to claim 1, which comprises in d) maintaining the polyester pellets at a temperature of at least about 2° C. below their melt temperature.

5. The method according to claim 1, which comprises in d) maintaining the polyester pellets at a temperature of at least about 10° C. below their melt temperature.

6. The method according to claim 1, which comprises generating the steam at a pressure of from 5 to 100 psi.

7. The method according to claim 1, which comprises generating the steam at a pressure of from 45 to 85 psi.

8. The method according to claim 1, which comprises generating the steam at a pressure of from 60 to 70 psi.

9. The method according to claim 1, wherein the mechanical energy is generated by a gas blower or fan.

10. The method of claim 9, wherein the turbine comprises a condensing turbine, said condensing turbine providing at least 10% of the power for the gas blower or fan.

11. The method according to claim 10, wherein in the condensing turbine provides at least 50% of the power for the gas blower or fan.

12. The method according to claim 10 wherein in the condensing turbine provides all of the power for the gas blower or fan.

13. The method according to claim 1, which further comprises removing impurities from the steam before providing the steam to the condensing turbine.

14. A method for integrating energy resources between a process for synthesizing terephthalic acid and a process for the solid-state polymerization of a polyester, which comprises:
a) generating heat from the synthesis of terephthalic acid,
b) transferring the generated heat to water to produce steam,
c) providing the steam to a turbine to generate electric power,
d) converting the electric power to mechanical power which creates a stream of gas, and
e) applying the stream of gas to polyester pellets in a crystallization process or a solid-state polymerization process.

15. The method according to claim 14, which comprises in e) applying the stream of gas to fluidize the polyester pellets in a crystallization process.

16. The method according to claim 14, which comprises in e) applying the stream of gas to fluidize the polyester pellets in a solid state polymerization process.

17. The method according to claim 14, which comprises in e) maintaining the polyester pellets at a temperature of at least about 2° C. below their melt temperature.

18. The method according to claim 14, which comprises in e) maintaining the polyester pellets at a temperature of at least about 10° C. below their melt temperature.

19. The method according to claim 14, which comprises generating the steam at a pressure of from 5 to 100 psi.

20. The method according to claim 14, which comprises generating the steam at a pressure of from 45 to 85 psi.

21. The method according to claim 14, which comprises generating the steam at a pressure of from 60 to 70 psi.

22. The method according to claim 14, wherein the mechanical energy is provided by a gas blower or fan.

23. The method according to claim 22, wherein the turbine comprises a condensing turbine, said condensing turbine providing at least 10% of the power for the gas blower or fan.

24. The method according to claim 23, wherein in the condensing turbine provides at least 50% of the power for the gas blower or fan.

25. The method according to claim 23 wherein in the condensing turbine provides all of the power for the gas blower or fan.
